(19) United States
(12) Patent Application Publication
(10) Pub. No.: US 2011/0027673 A1
(43) Pub. Date: Feb. 3, 2011

(54) SOLID OXIDE FUEL CELL SYSTEM WITH INTEGRAL GAS TURBINE AND THERMOPHOTOVOLTAIC THERMAL ENERGY CONVERTERS

(75) Inventors: Alex Ignatiev, Houston, TX (US); William Benton Wedeking, Houston, TX (US)

Correspondence Address: ROBERT W STROZIER, P.L.L.C, PO BOX 429, BELLAIRE, TX, 77402-0429, US

(73) Assignee: QUARIUS TECHNOLOGIES, INC.

(21) Appl. No.: 12/828,191

(22) Filed: Jun. 30, 2010

Related U.S. Application Data
(60) Provisional application No. 61/230,126, filed on Jul. 31, 2009.

(51) Int. Cl. H01M 8/06; H01M 8/10

(52) U.S. Cl. 429/423; 429/488

(57) ABSTRACT

A maximal efficiency solid oxide fuel cell (SOFC), gas turbine (GT) and thermophotovoltaic (TPV) system is described. The anode exhaust of the SOFC is used to drive the GT component, and the waste radiative heat of the SOFC is used to power the TPV component, with all three components producing electrical energy. The turbine exhaust can further be utilized for process heat applications or additional Carnot heat engine applications.

### RELATED APPLICATIONS

This application claims priority to and the benefit of U.S. Provisional Patent Application Ser. No. 61/230126, filed 31 Jul. 2009 (07/31/2009).

### BACKGROUND OF THE INVENTION

1. Field of the Invention

Embodiments of the present invention relate to a system that performs efficiently and exhausts a limited number of gases including CO₂ thus allowing for more direct CO₂ capture and sequestration.

More particularly, embodiments of the present invention relate to systems and methods for producing electric power, where the systems include at least a solid oxide hydrogen/oxygen fuel cell subsystem, a turbine subsystem and a thermophotovoltaic subsystem. The fuel cell subsystem generates electric energy from the conversion of a chemical energy in the oxidation of hydrogen by oxygen; the turbine subsystem generates electric energy from heat retained in the exhaust gas from the fuel cell subsystem; and the thermophotovoltaic subsystem generates electric energy from the heat in the high temperature fuel cell directly or indirectly. The systems also include a power conditioner adapted to receive the electrical input contributions from the subsystems and produce a regulated electrical output.

2. Description of the Related Art

Fuel cells have become of significant interest for converting chemical energy, in the form of a hydrogen and oxygen reaction, into electrical energy. Of specific interest are solid oxide fuel cells, which: (a) combine oxygen ions diffusing from the cathode through the electrolyte with hydrogen ions (protons) present at the anode to form water, (2) apply an electrical potential of approximately 1.1 V across the anode and cathode driving electrons from the anode through a current loop to the cathode, and (3) doing work upon a load located within that current loop. Solid oxide fuel cells (SOFCs) operate at very high temperatures (typically 750° C. to 1,000° C.) so as to assure high permeability of the electrolyte layer to oxygen with resultant high performance. SOFCs have achieved efficiencies in electrochemical conversion of greater than 50%. Even under such conditions, a significant amount of the converted chemical energy is lost to waste heat both in the exhaust gas of the SOFCs, and in the radiation loss of the SOFCs.

Past approaches of utilizing SOFC waste heat have included the integration of a gas turbine with the SOFC. Such proposed integration has been both on the topping side (U.S. Pat. Nos. 5,449,5685; 541,014; 5,968,680), and the bottoming side (U.S. Pat. Nos. 5,413,879; 5,811,201; 5,693,201; 5,976,332; 6,365,290; U.S. Pub. Nos. 2005/0196659A1; 2007/0163822A1) of the SOFC with the turbine increasing the SOFC operating pressure and hence efficiency, when used on the topping side, and the SOFC feeding hot exhaust gas (both anode and cathode exhaust) to the turbine (along with possible additional combustion—U.S. Pat. Nos. 5,413,879; 6,365,290 and U.S. Pub. No. 2007/0163822A1) as the turbine power source. The turbine power is then used either for compressing gases for the SOFC or surrounding environments, or for turning a generator with electrical energy as an output. A topping side turbine approach requires additional expense to support the higher pressure of the SOFC vessel. A bottoming side turbine directly uses the SOFC exhaust gases for operation, but often uses additional combustion to increase exhaust gas temperature and hence increased turbine performance. This, however, adds the complexity of combustion to the SOFC exhaust gas path. In both cases, however, additional electrical energy is generated by the hybrid system.

Other past approaches of utilizing SOFC waste heat in the form of radiation include the addition of thermophotovoltaic (TPV) elements either into the exhaust gas stream of the SOFC, or as a heat absorbing liner around the SOFC (U.S. Pat. No. 6,423,896; U.S. Pub. No. 2004/0101750A1; U.S. Pub. No. 2005/0074646A1; U.S. Pub. No. 2005/0236034A1). Both approaches are functional, though not yet commercial, and rely on the temperature environment of the thermophotovoltaic placement and on the thermophotovoltaic performance based on its electronic/chemical structure. The addition of thermophotovoltaic elements will result in increased electrical output from the hybrid system.

What is needed now in the art of hybrid SOFC systems is the integration of both the gas turbine and the TPV system with the SOFC for maximal efficiency of operation for the complete system. What is further needed is a combined SOFC/GT/TPV energy system that has an efficiency approaching and/or surpassing 70%. What is further needed is a combined SOFC/GT/TPV energy system that has no combustion associated with it allowing for only CO₂, water vapor and N₂ as exhaust gases.

### SUMMARY OF THE INVENTION

Embodiments of the invention provide systems for efficiently generating electrical energy. The systems comprise a solid oxide fuel cell (SOFC) subsystem to generate electrical energy from chemical energy released in the reaction of hydrogen with oxygen, a gas turbine subsystem working on the bottoming side of the fuel cell utilizing the fuel cell exhaust as the energy source to turn the turbine, which is connected to a generator thus generating electrical energy, and a thermophotovoltaic (TPV) subsystem utilizing radiation energy including infrared energy from the fuel cell to convert into electrical energy, where the TPV subsystem can be in direct thermal contact with the fuel cell, in thermal proximity to the fuel cell, in thermal contact with the hot exhaust from the fuel cell or thermally coupled to the fuel cell via a high temperature heat transfer fluid.

Embodiment of the invention provide systems for efficiently generating electrical energy. The systems comprise a solid oxide fuel cell to generate electrical energy from chemical energy released in the reaction of hydrogen with oxygen, where the hydrogen is obtained from the catalytic reduction of complex hydrocarbons within a reformer integral with the SOFC, a gas turbine working on the bottoming side of the fuel cell utilizing the fuel cell exhaust as the energy source to turn the turbine which is connected to a generator thus generating electrical energy, and a thermophotovoltaic infrared energy absorber in thermal proximity to the fuel cell and utilizing radiation energy from the fuel cell to convert into electrical energy.

Embodiment of the inventions provide systems for efficiently generating electrical energy. The systems comprise a solid oxide fuel cell to generate electrical energy from chemical energy released in the reaction of hydrogen with oxygen where the hydrogen is obtained directly as a gas or from a reformer, a gas turbine working on the bottoming side of the fuel cell utilizing the fuel cell exhaust as the energy source to turn the turbine which is connected to a generator thus generating electrical energy, a thermophotovoltaic infrared energy absorber in thermal proximity to the fuel cell and utilizing radiation energy from the fuel cell to convert into electrical energy, and an additional use of the turbine exhaust to drive a Carnot heat engine.

Embodiments of the inventions provide systems for efficiently generating electrical energy. The systems comprise a solid oxide fuel cell to generate electrical energy from chemical energy released in the reaction of hydrogen with oxygen where the hydrogen is obtained directly as a gas or from a reformer, a gas turbine working on the bottoming side of the fuel cell utilizing the fuel cell exhaust as the energy source to turn the turbine which is connected to a generator thus generating electrical energy, a thermophotovoltaic infrared energy absorber in thermal proximity to the fuel cell and utilizing radiation energy from the fuel cell to convert into electrical energy, and an additional use of the turbine exhaust as process heat to use as example in water heating, air heating, drying, desalination or other heat requirement needs.

### BRIEF DESCRIPTION OF THE DRAWINGS

The invention can be better understood with reference to the following detailed description together with the appended illustrative drawings in which like elements are numbered the same:

FIG. 1 illustrates an embodiment of a chemical energy to electrical energy conversion system including a solid oxide fuel cell with integrated thermophotovoltaic cells, and whose exhaust is conveyed to a gas turbine/generator. The electrical outputs of the three components of the energy conversion system are channeled to a power conditioning module which is then yields output electrical energy for use.

FIG. 2 illustrates another embodiment of a chemical energy to electrical energy conversion system including a solid oxide fuel cell with a high temperature transfer fluid reservoir and heat transfer unit integrated with thermophotovoltaic cells, and whose exhaust is conveyed to a gas turbine/generator. The electrical outputs of the three components of the energy conversion system are channeled to a power conditioning module which is then yields output electrical energy for use.

FIG. 3 illustrates another embodiment of a chemical energy to electrical energy conversion system including a solid oxide fuel cell with an integrated fuel reformer and integrated thermophotovoltaic cells, and whose exhaust is conveyed to a gas turbine/generator. The electrical outputs of the three components of the energy conversion system are channeled to a power conditioning module which is then yields output electrical energy for use.

FIG. 4 illustrates another embodiment of a chemical energy to electrical energy conversion system including a solid oxide fuel cell with an integrated fuel reformer and integrated thermophotovoltaic cells, and whose exhaust is conveyed to a gas turbine/generator. The electrical outputs of the three components of the energy conversion system are channeled to a power conditioning module which is then yields output electrical energy for use. Further, the low quality heat exhaust of the turbine is channeled to a Carnot heat engine for additional energy utilization.

FIG. 5 illustrates another embodiment of a chemical energy to electrical energy conversion system including a solid oxide fuel cell with an integrated fuel reformer and integrated thermophotovoltaic cells, and whose exhaust is conveyed to a gas turbine/generator. The electrical outputs of the three components of the energy conversion system are channeled to a power conditioning module which is then yields output electrical energy for use. Further, the low quality heat exhaust of the turbine is channeled to a process heat utilization system such as a desalinator or an air or water heater.

FIG. 6 illustrates another embodiment of a chemical energy to electrical energy conversion system including a solid oxide fuel cell with an integrated fuel reformer and integrated thermophotovoltaic cells that are mounted at or in the exhaust stream of the SOFC which is also conveyed to a gas turbine/generator. The electrical outputs of the three components of the energy conversion system are channeled to a power conditioning module which is then yields output electrical energy for use.

### DETAILED DESCRIPTION OF THE INVENTION

The inventors have found that embodiments of energy conversion systems can be constructed that combine: (a) a solid oxide fuel cell as one component generating electrical energy and emanating waste heat in the form of hot exhaust or infrared radiation, (b) the waste heat in the from of exhaust being utilized by a second component, a gas turbine, which is turned by the SOFC exhaust and in turn, rotates a generator producing electrical energy, and (c) a third component, thermophotovoltaic cells, which are bathed in the infrared radiation emitted by the SOFC, and in turn convert the infrared radiation directly to electrical energy. The thermophotovoltaic cells can also be placed at the exhaust of the SOFC to utilize the infrared radiation from the hot exhaust gases of the SOFC.

Embodiments of the present invention relate broadly to systems for converting chemical energy into electrical energy, where the system include a solid oxide fuel cell subsystem, a turbine subsystem and a thermophotovoltaic cell subsystem, where the solid oxide fuel cell subsystem oxides hydrogen in the presence of oxygen at high temperature to produce water, generate electric energy, and produce an exhaust gas. The thermophotovoltaic cell subsystem converts a portion of the heat in the form of infra-red radiation from the solid oxide fuel cell directly into electric energy, where the thermophotovoltaic cell(s) of the subsystem are either in direct contact with the fuel cell or are in indirect thermal contact with the fuel cell via a high temperature heat transfer fluid. The turbine subsystem converts a portion of the heat in the exhaust gas to electric energy as the exhaust gas passes through the turbine subsystem. Suitable high temperature heat transfer fluids include liquid metals such as lithium, sodium, sodium-potassium alloys, lead, lead-bismuth alloys or other metals or metal alloys that are liquids between about 750° C. and about 1,000° C., salts having melting points between about 750° C. and about 1,000° C., other high temperature heat transfer fluids, or mixtures and combinations thereof.

Embodiments of the present invention relate broadly to method for converting chemical energy into electrical energy, where the method include supply a source of hydrogen and a source of oxygen to a solid oxide fuel cell subsystem. The method also includes oxidizing the hydrogen in the presence of the oxygen at high temperature to generate electric energy and a hot exhaust gas. The method also includes converting a portion of the heat generated by the solid oxide fuel cell subsystem in the form of infra-red radiation directly into electric energy via a thermophotovoltaic cell subsystem. The method also includes forwarding the exhaust gas to a turbine subsystem, where a portion of the heat in the exhaust gas is converted to electrical energy as the gas passes through the turbine subsystem.

The present invention relates to systems for generating electrical energy. The systems include a fuel cell subsystem including at least one solid oxide fuel cell, where the subsystem converts a portion of chemical energy released in the reaction of hydrogen with oxygen into a first amount of electrical energy and produces a hot exhaust gas comprising substantially water vapor, where each fuel cell includes a hydrogen gas input connected to a hydrogen gas source and an oxygen gas input connected to an oxygen source. The system also include a turbine subsystem connected to a bottoming side of the fuel cells, where the turbine subsystem includes at least one gas turbine, which converts a portion of heat energy in the hot exhaust gas from the fuel cells into a second amount of electrical energy and form a turbine exhaust gas. The system also includes a thermophotovoltaic subsystem including at least one thermophotovoltaic cell in thermal contact with the fuel cells, where the thermophotovoltaic subsystem converts a portion of radiant energy produced by the fuel cells into a third portion of electrical energy.

The radiant energy is infrared radiant energy used by the thermophotovoltaic subsystem. The thermophotovoltaic cells are in direct thermal contact with the fuel cells. The thermophotovoltaic cells are in indirect thermal contact with the fuel cell via a high temperature heat transfer fluid. The thermophotovoltaic cells are in direct thermal contact with the hot exhaust gas from the fuel cells. The thermophotovoltaic subsystem further includes an emitter coupled to each thermophotovoltaic cell, where the emitters are adapted to convert a portion of the radiant energy into a narrow range of infrared radiant energy to improve an efficiency of the thermophotovoltaic cells.

The system may further include a power conditioner adapted to receive the three electrical energy amounts and produce a regulated electrical energy output, where the regulated electrical energy output is used by a load connected to the system or is fed into a power grid.

The fuel cell subsystem further includes at least one reformer having a fuel input connected to a fuel source and a steam input connected to a steam source, where the reformer converts the fuel in the presence of steam into hydrogen gas and carbon dioxide gas, the hydrogen gas is forwarded to the hydrogen gas input of the fuel cells and the carbon dioxide gas is vented or sequestered.

The systems may further include a Carnot heat engine connected to the turbine, where the Carnot heat engine converts a portion of residual heat in the turbine exhaust gas to usable form of energy.

The systems may further include a heat utilization unit or a plurality of heat utilization units, where the units utilize a portion of residual heat in the turbine exhaust gas and where the units comprise a water heating unit, an air or gas heating unit, a drying unit, a desalination unit and/or other units that utilized waste heat.

The present invention also relates to systems for generating electrical energy. The systems include a fuel cell subsystem including at least one solid oxide fuel cell and at least one reformer, where the subsystem converts a portion of chemical energy released in the reaction of hydrogen with oxygen into a first amount of electrical energy and produces a hot exhaust gas comprising substantially water vapor, where each fuel cell includes a hydrogen gas input and an oxygen gas input connected to an oxygen source, and where each reformer includes a fuel input connected to a fuel source and a steam input connected to a steam source, where the reformer converts the fuel in the presence of steam into hydrogen gas and carbon dioxide gas, the hydrogen gas is forwarded to the hydrogen gas input of the fuel cells and the carbon dioxide gas is vented or sequestered. The systems also include a turbine subsystem connected to a bottoming side of the fuel cells, where the turbine subsystem includes at least one gas turbine, which converts a portion of heat energy in the hot exhaust gas from the fuel cells into a second amount of electrical energy. The systems also include a thermophotovoltaic subsystem including at least one thermophotovoltaic cell in thermal contact with the fuel cells, where the thermophotovoltaic subsystem converts a portion of radiant energy produced by the fuel cells into a third portion of electrical energy.

The radiant energy is infrared radiant energy used by the thermophotovoltaic subsystem. The thermophotovoltaic cells are in direct thermal contact with the fuel cells. The thermophotovoltaic cells are in indirect thermal contact with the fuel cell via a high temperature heat transfer fluid. The thermophotovoltaic cells are in direct thermal contact with the hot exhaust gas from the fuel cells. The thermophotovoltaic subsystem further includes an emitter coupled to each thermophotovoltaic cell, where the emitters are adapted to convert a portion of the radiant energy into a narrow range of infrared radiant energy to improve an efficiency of the thermophotovoltaic cells.

The system may further include a power conditioner adapted to receive the three electrical energy amounts and produce a regulated electrical energy output, where the regulated electrical energy output is used by a load connected to the system or is fed into a power grid.

The systems may further include a Carnot heat engine connected to the turbine, where the Carnot heat engine converts a portion of residual heat in the turbine exhaust gas to usable form of energy.

The systems may further include a heat utilization unit or a plurality of heat utilization units, where the units utilize a portion of residual heat in the turbine exhaust gas and where the units comprise a water heating unit, an air or gas heating unit, a drying unit, a desalination unit and/or other units that utilized waste heat.

The present invention also relates to methods for generating electrical energy. The methods include generating a first amount of electrical energy in a fuel cell subsystem including at least one solid oxide fuel cell, where the subsystem converts a portion of chemical energy released in the reaction of hydrogen with oxygen into the first amount of electrical energy and produces a hot exhaust gas comprising substantially water vapor, where each fuel cell includes a hydrogen gas input connected to a hydrogen gas source and an oxygen gas input connected to an oxygen source. The methods also include generating a second amount of electrical energy in a turbine subsystem connected to a bottoming side of the fuel cells, where the turbine subsystem includes at least one gas turbine, which converts a portion of heat energy in the hot exhaust gas from the fuel cells into the second amount of electrical energy. The methods also include generating a third amount of electrical energy in a thermophotovoltaic subsystem including at least one thermophotovoltaic cell in thermal contact with the fuel cells, where the thermophotovoltaic subsystem converts a portion of radiant energy produced by the fuel cells into the third portion of electrical energy. The systems may further include conditioning the three amounts of electrical energy in a conditioning unit to form a regulated electrical energy output, where the regulated electrical energy output drives a load and/or is fed into an electrical power grid.

### DETAILED DESCRIPTION OF THE DRAWINGS

### First Embodiment

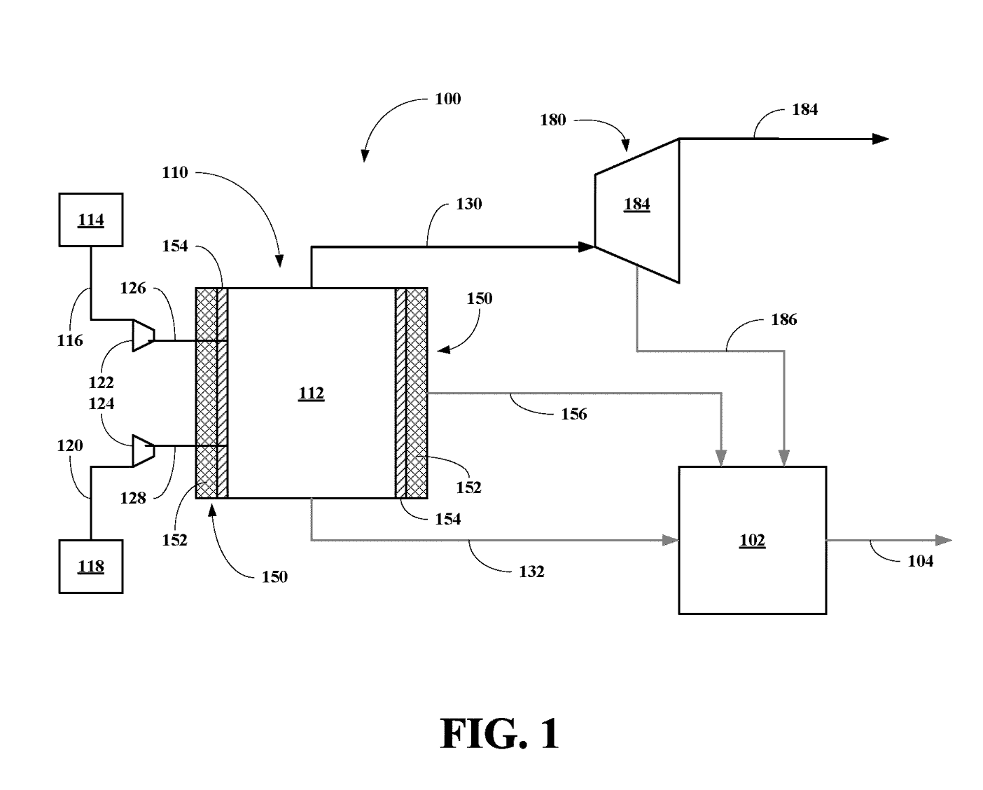

Referring now to FIG. 1, an embodiment of the system of this invention, generally 100, is shown, where the system 100 is an energy conversion system, combining a solid oxide fuel cell subsystem 110, a thermophotovoltaic cell subsystem 150, and a gas turbine subsystem 180. The solid oxide fuel cell subsystem 110 includes at least one solid oxide fuel cell (SOFC) 112. Each SOFC 112 includes, as chemical inputs, a hydrogen gas source 114 for supplying a hydrogen gas stream 116 to the SOFC 112 and a oxygen gas source 118 for supplying oxygen gas stream 120 to the SOFC 112 via appropriate conduits. The gases may be compressed for above ambient pressure operation of the SOFC 112, and the gas may be compressed by the turbine subsystem 180 or via a separate gas compressors 122 and 124 to form a compressed hydrogen gas stream 126 and a compressed oxygen gas stream 128, respectively.

The SOFC 112 is operated at high temperature typically between about 750° C. and 1,000° C. Such high temperatures are required for adequate permeability of the fuel cell oxide electrolyte to oxygen ions, which principally defines the conversion efficiency of the SOFC 112. The operation of the SOFC subsystem 110 at elevated temperatures incorporates the chemical reaction of hydrogen with oxygen to form water. The oxygen in the oxygen gas stream 120 or 128 (typically obtained from air) is exposed to the cathode side of the SOFC 112 which is typically a mixed electronic/ionic conducting oxide (conducts electrons and ions). The oxygen in the oxygen gas stream 120 or 128 is dissociated and ionized at the cathode by picking up two electrons per ion from an external circuit, with the oxygen ions diffusing though the cathode and through the adjacent electrolyte (typically yttria stabilized zirconia, or samarium or gadolinium-doped ceria, or other oxide electrolyte) and arriving at the anode triple-phase boundary (the meeting of anode, electrolyte and hydrogen), where the oxygen ions react with the hydrogen in the hydrogen stream 116 or 126. The hydrogen in the hydrogen gas stream 116 or 126 is dissociated and ionized at the anode, with the hydrogen ions (protons) reacting with the oxygen ions to generate water molecules and energy (about 1.1 eV), which moves the stripped electrons from the hydrogen through the electrical circuit. For the SOFC 112, the higher the temperature the more rapidly the oxygen ions diffuse through the electrolyte, and hence the greater the current output and thus power output from the SOFC 112. The operating temperature limit near 1,000° C. occurs due to reduced stability of structural and encapsulation materials required to assemble and support the SOFC 112. The temperature of the formed water (vapor) which is exhausted as an exhaust stream 130 is therefore near but less than the operating temperature of the SOFC, and the high temperature water vapor can be used to power a gas turbine either directly or through a heat exchanger to another operating gas. The DC electrical output of the SOFC 112 is conveyed to via a SOFC electric conduit 132 to a power conditioner 102. The power conditioner 102 conditions input electric power into an output regulated electric power 104 that may be utilized by a load (not shown), which may be either a local load or the electrical grid.

As a result of the high temperature operation of the SOFC 112, the SOFC 112 must be insulated from its room temperature surroundings to prevent radiative/conductive heat losses to the surroundings. The radiant energy produce by the SOFC 112 is principally in the infrared range of the electromagnetic spectrum, which is used by the thermophotovoltaic cell subsystem 150. The infrared radiation may be absorbed and converted into electrical energy in the thermphotovoltaic (TPV) subsystem 150 in one thermophotovoltaic (TPV) cell 152 or a plurality of TPV cells 152. Such cells 152 are essentially solar cells (p-n junctions) having a small band gap that operate in the infrared part of the electromagnetic spectrum. The TPV cells 152 line the SOFC cells 112 and absorb the radiated infrared radiation from the SOFC cells 112 and converting a portion of the infrared radiation into electric energy.

The TPV cells 152 are typically direct gap compound semiconductors of the classes gallium antimonide, indium gallium arsenide, indium gallium arsenide antimonide, indium phosphide arsenide antimonide, other compound semiconductors or mixtures and combinations thereof, where the semiconductors have band gaps less than or equal to about 0.6 eV. Materials with such electronic properties may absorb photons in the infrared region of the spectrum (heat), and with the presence of a p-n junction or equivalent, may prevent re-combination of the electron-hole pairs created and allow for utilization of the electron that has been put into the conduction band for doing work. In this scenario, the higher the temperature of a radiating material, the higher the radiated energy, and the larger the electron current obtained from the TPV cells 152. Further, the lower the bandgap of the TPV material, the higher the TPV current resulting from a radiating material held at a constant temperature.

Efficiency of the TPV subsystem 150 may be further enhanced through the addition of a selective emitter 154, which absorbs the broad infrared radiation from a heat source (Plank distribution) and re-emits a major portion of that radiation in a more narrow wavelength band that better coincides with the bandgap of the TPV material, thus increasing the amount of radiation absorbed by the TPV cells 152, and hence increasing efficiency. Such selective emitters 154 typically comprise silicon carbide, tungsten, oxides such as ytterbium oxide, erbium oxide and complex ternary and quaternary rare earth oxides along with mixed oxides of aluminum, cobalt and other metals. The TPV configuration referred to in this embodiment of the subsystem 150 incorporates both the TPV cells 152 and the selective emitter 154. The TPV subsystem 150 produces a DC output, which is conducted via an electrical conduit 156 to the power conditioner 102.

As noted, the exhaust stream 130 from the SOFC 112 contains essentially water vapor at near the temperature of operation of the SOFC 112. Because a typical SOFC operates near 50% efficiency nearly ½ of the energy going into the SOFC 112 as chemical energy is lost in the exhaust stream 130 as heat. Much of this lost heat energy can be recouped by passing the exhaust stream 130 through a gas turbine subsystem 180. The subsystem 180 includes at least one gas turbine 182. The SOFC exhaust stream 130 is forwarded to the turbine 182, where the turbine 182 converts a portion of the heat in the stream 130 to form a spent exhaust stream 184 and to produce electrical energy. The turbine configuration referred to in this embodiment 180 incorporates both the turbine and an electrical generator. The electrical generator output (either AC or DC) is forwarded to the conditioner 102 via a turbine electrical conduit 186, which converts the power to a regulated power 104 that can be utilized by the load which could be either a local load or the electrical grid. The turbine exhaust stream 184 may be vented, or as described in another embodiment, may be channeled to a Carnot heat engine as described below or used as process heat. This process heat may also be used to pre-heat the hydrogen and/or the oxygen for the fuel cell 112.

### Second Embodiment

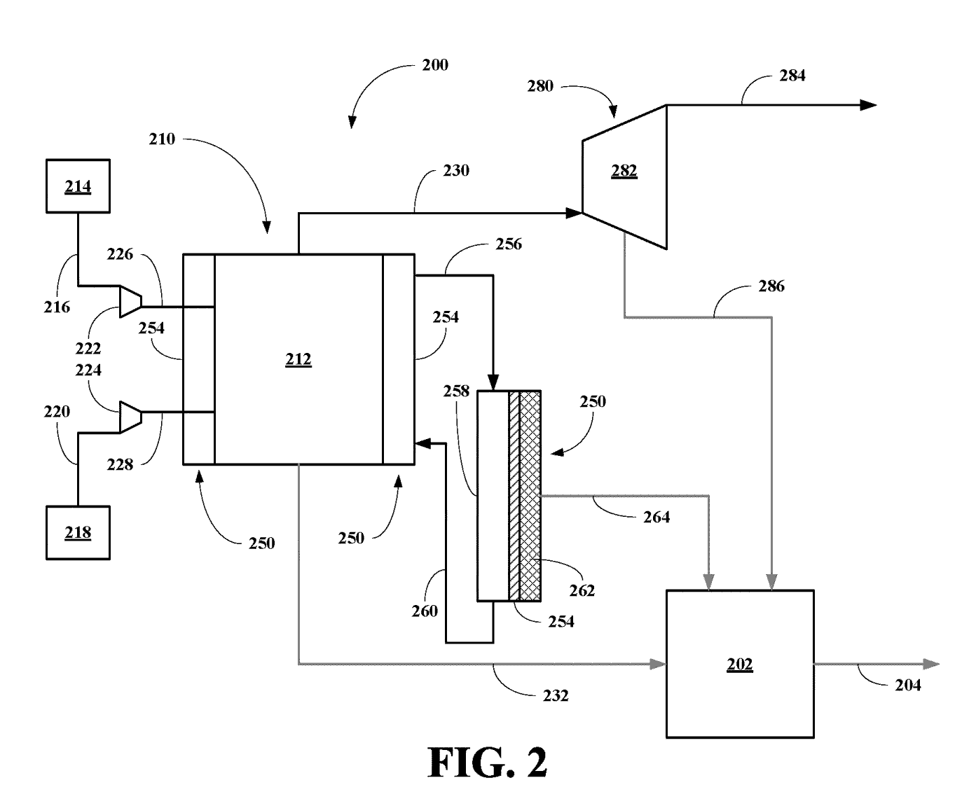

Referring now to FIG. 2, another embodiment of the system of this invention, generally 200, is shown, where the system 200 is an energy conversion system, combining a solid oxide fuel cell subsystem 210, a thermophotovoltaic cell subsystem 250, and a gas turbine subsystem 280. The solid oxide fuel cell subsystem 210 includes at least one solid oxide fuel cell (SOFC) 212. Each SOFC 212 includes, as chemical inputs, a hydrogen gas source 214 for supplying a hydrogen gas stream 216 to the SOFC 212 and a oxygen gas source 218 for supplying oxygen gas stream 220 to the SOFC 212 via appropriate conduits. The gases may be compressed for above ambient pressure operation of the SOFC 212, and the gas may be compressed by the turbine subsystem 280 or via a separate gas compressors 222 and 224 to form a compressed hydrogen gas stream 226 and a compressed oxygen gas stream 228, respectively. The SOFC 212 produces an exhaust stream 230 of essentially water vapor is therefore near but less than the operating temperature of the SOFC, and the high temperature water vapor can be used to power a gas turbine either directly or through a heat exchanger to another operating gas. The DC electrical output of the SOFC 212 is conveyed to via a SOFC electric conduit 232 to a power conditioner 202. The power conditioner 202 conditions input electric power into an output regulated electric power 204 that may be utilized by a load (not shown), which may be either a local load or the electrical grid.

As a result of the high temperature operation of the SOFC 212, the SOFC 212 must be insulated from its room temperature surroundings to prevent radiative/conductive heat losses to the surroundings. The radiant energy produce by the SOFC 212 is principally in the infrared range of the electromagnetic spectrum, which is used by the thermophotovoltaic cell subsystem 250. The infrared radiation may be absorbed and converted into electrical energy in the thermphotovoltaic (TPV) subsystem 250 in one thermophotovoltaic (TPV) cell 252 or a plurality of TPV cells 252. Such cells 252 are essentially solar cells (p-n junctions) having a small band gap that operate in the infrared part of the electromagnetic spectrum. In this embodiment 250, the TPV cells 252 are not in direct contact with the SOFC 212, but are in indirect thermal contact with the SOFC 212 via a high temperature heat transfer fluid. The SOFC 212 is surrounded by a high temperature heat transfer fluid reservoir 254. A stream 256 of hot high temperature heat transfer fluid is forwarded to a heat transfer unit 258, which is in contact with the TPV cell 252, where the TPV cell 252 absorbs the radiated infrared radiation from the stream 256 in the unit 258 to produce a cooled high temperature transfer fluid stream 260 and electric energy. The cooled high temperature transfer fluid stream 260 is returned to the reservoir 254 forming a closed loop.

Efficiency of the TPV subsystem 250 may be further enhanced through the addition of a selective emitter 262, which absorbs the broad infrared radiation from a heat source (Plank distribution) and re-emits a major portion of that radiation in a more narrow wavelength band that better coincides with the bandgap of the TPV material, thus increasing the amount of radiation absorbed by the TPV cells 252, and hence increasing efficiency. Such selective emitters 262 typically comprise silicon carbide, tungsten, oxides such as ytterbium oxide, erbium oxide and complex ternary and quaternary rare earth oxides along with mixed oxides of aluminum, cobalt and other metals. The TPV configuration referred to in this embodiment of the subsystem 250 incorporates both the TPV cells 252 and the selective emitter 262. The TPV subsystem 250 produces a DC output, which is conducted via an electrical conduit 264 to the power conditioner 202.

As noted, the exhaust stream 230 from the SOFC 212 contains essentially water vapor at near the temperature of operation of the SOFC 212. Because a typical SOFC operates near 50% efficiency nearly ½ of the energy going into the SOFC 212 as chemical energy is lost in the exhaust stream 230 as heat. Much of this lost heat energy can be recouped by passing the exhaust stream 230 through a gas turbine subsystem 280. The subsystem 280 includes at least one gas turbine 282. The SOFC exhaust stream 230 is forwarded to the turbine 282, where the turbine 282 converts a portion of the heat in the stream 230 to form a spent exhaust stream 284 and to produce electrical energy. The turbine configuration referred to in this embodiment 280 incorporates both the turbine and an electrical generator. The electrical generator output (either AC or DC) is forwarded to the conditioner 202 via a turbine electrical conduit 286, which converts the power to a regulated power 204 that can be utilized by the load which could be either a local load or the electrical grid. The turbine exhaust stream 284 may be vented, or as described in another embodiment, may be channeled to a Carnot heat engine as described below or used as process heat. This process heat may also be used to pre-heat the hydrogen and/or the oxygen for the fuel cell 212.

### Third Embodiment

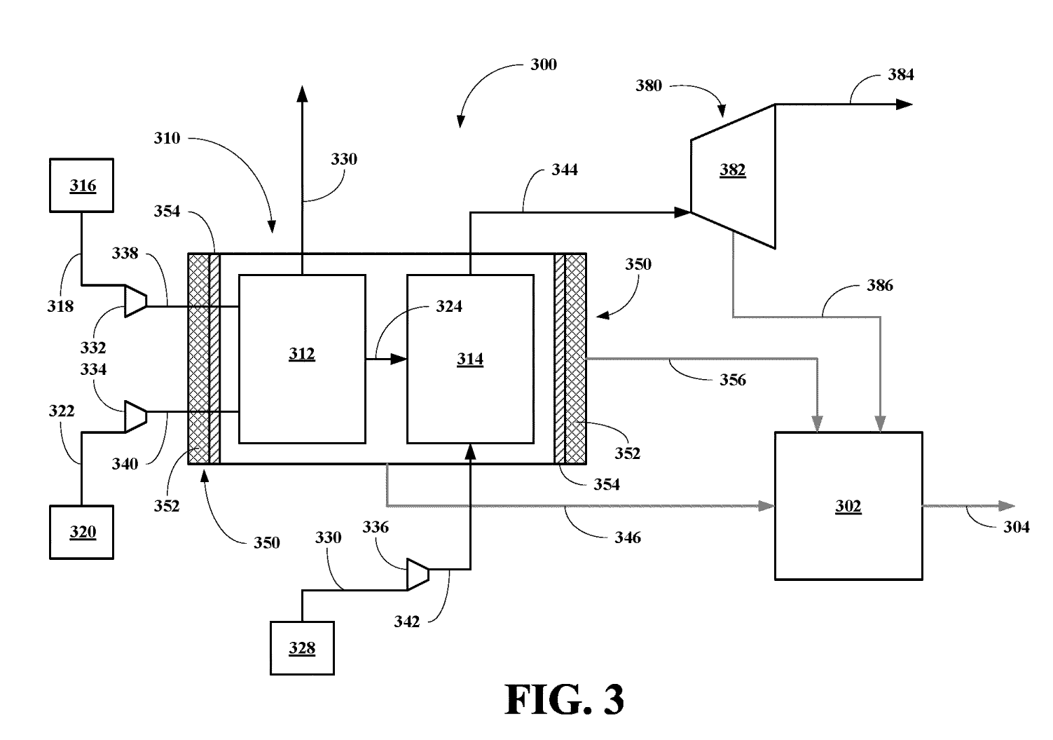

Referring now to FIG. 3, another embodiment of the system of this invention, generally 300, is shown, where the system 300 is an energy conversion system, combining a solid oxide fuel cell subsystem 310, a thermophotovoltaic cell subsystem 350, and a gas turbine subsystem 380. The solid oxide fuel cell subsystem 310 includes at least one reformer 312 and at least one solid oxide fuel cell (SOFC) 314.

The reformer 312 includes a fuel source 316 for supplying a fuel stream 318 to the reformer 312 and a steam source 320 for supplying a steam stream 322 to the reformer 312 via appropriate conduits. The reformer 312 reforms the fuel and steam into hydrogen gas and carbon dioxide gas. The hydrogen gas is forwarded to the SOFC 314 as a hydrogen stream 324, while the carbon dioxide leaves the reformer 312 as a carbon dioxide gas stream 326.

The SOFC 314 includes a oxygen gas source 328 for supplying an oxygen gas stream 330 to the SOFC 314 via appropriate conduits. The gases may be compressed for above ambient pressure operation of the reformer 314 and the SOFC 314, and the gas may be compressed by the turbine subsystem 380 or via a separate gas compressors 332, 334 and 336 to form a compressed fuel stream 338, a compressed steam stream 340, and a compressed oxygen stream 342, respectively. The SOFC 314 produces an exhaust stream 344 of essentially water vapor is therefore near but less than the operating temperature of the SOFC, and the high temperature water vapor can be used to power a gas turbine either directly or through a heat exchanger to another operating gas. The DC electrical output of the SOFC 314 is conveyed to via a SOFC electric conduit 346 to a power conditioner 302. The power conditioner 302 conditions input electric power into an output regulated electric power 304 that may be utilized by a load (not shown), which may be either a local load or the electrical grid.

As a result of the high temperature operation of the SOFC 314, the SOFC 314 must be insulated from its room temperature surroundings to prevent radiative/conductive heat losses to the surroundings. The radiant energy produce by the SOFC 314 is principally in the infrared range of the electromagnetic spectrum, which is used by the thermophotovoltaic cell subsystem 350. The infrared radiation may be absorbed and converted into electrical energy in the thermphotovoltaic (TPV) subsystem 350 in one thermophotovoltaic (TPV) cell 352 or a plurality of TPV cells 352. Such cells 352 are essentially solar cells (p-n junctions) having a small band gap that operate in the infrared part of the electromagnetic spectrum. The TPV cells 352 line the SOFC cells 314 and absorb the radiated infrared radiation from the SOFC cells 314 and converting a portion of the infrared radiation into electric energy.

Efficiency of the TPV subsystem 350 may be further enhanced through the addition of a selective emitter 354, which absorbs the broad infrared radiation from a heat source (Plank distribution) and re-emits a major portion of that radiation in a more narrow wavelength band that better coincides with the bandgap of the TPV material, thus increasing the amount of radiation absorbed by the TPV cells 352, and hence increasing efficiency. Such selective emitters 354 typically comprise silicon carbide, tungsten, oxides such as ytterbium oxide, erbium oxide and complex ternary and quaternary rare earth oxides along with mixed oxides of aluminum, cobalt and other metals. The TPV configuration referred to in this embodiment of the subsystem 350 incorporates both the TPV cells 352 and the selective emitter 354. The TPV subsystem 350 produces a DC output, which is conducted via an electrical conduit 356 to the power conditioner 302.

As noted, the exhaust stream 330 from the SOFC 314 contains essentially water vapor at near the temperature of operation of the SOFC 314. Because a typical SOFC operates near 50% efficiency nearly ½ of the energy going into the SOFC 314 as chemical energy is lost in the exhaust stream 330 as heat. Much of this lost heat energy can be recouped by passing the exhaust stream 330 through a gas turbine subsystem 380. The subsystem 380 includes at least one gas turbine 382. The SOFC exhaust stream 330 is forwarded to the turbine 382, where the turbine 382 converts a portion of the heat in the stream 330 to form a spent exhaust stream 384 and to produce electrical energy. The turbine configuration referred to in this embodiment 380 incorporates both the turbine and an electrical generator. The electrical generator output (either AC or DC) is forwarded to the conditioner 302 via a turbine electrical conduit 386, which converts the power to a regulated power 304 that can be utilized by the load which could be either a local load or the electrical grid. The turbine exhaust stream 384 may be vented, or as described in another embodiment, may be channeled to a Carnot heat engine as described below or used as process heat. This process heat may also be used to pre-heat the hydrogen and/or the oxygen for the fuel cell 314.

Suitable fuels include, without limitation, methane, propane, butane, gasoline, diesel, ethanol, methanol, coal gas, biofuels, other types of hydrocarbon fuels that can be used in the reformer 312 or mixtures and combinations thereof. The fuel undergoes a reaction in the presence of a water gas shift catalyst to produce hydrogen gas and CO₂ gas.

### Fourth Embodiment

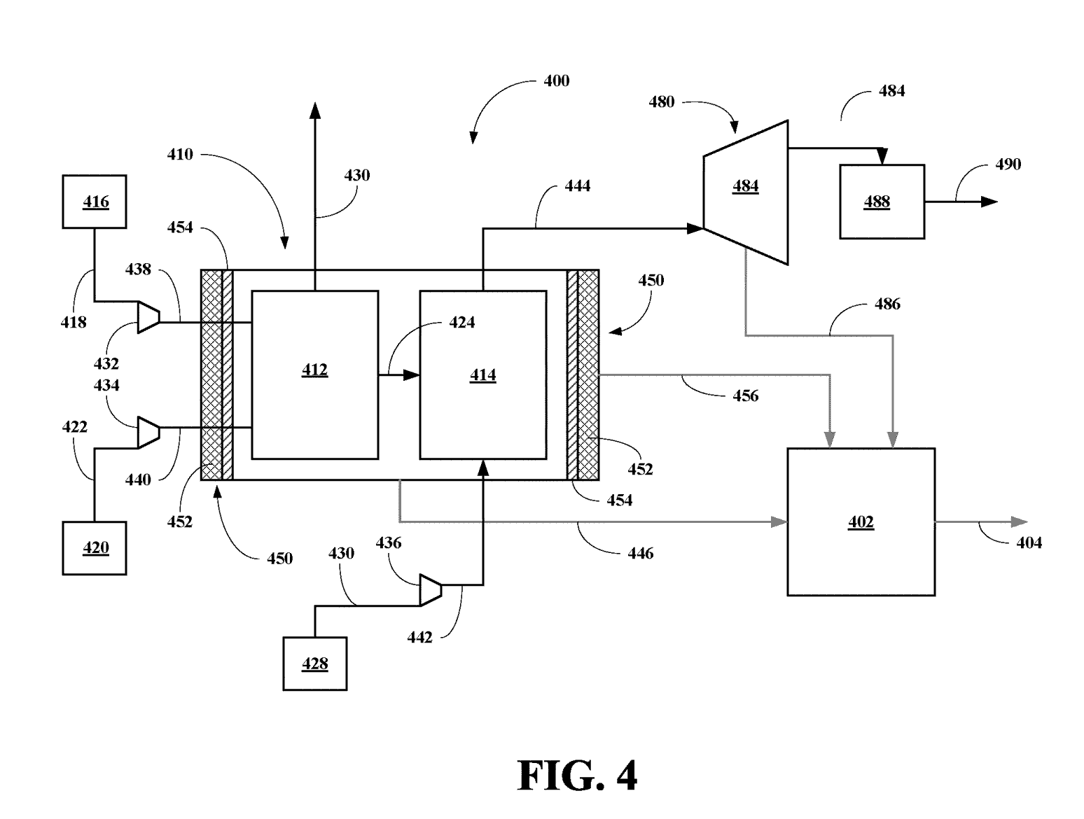

Referring now to FIG. 4, another embodiment of the system of this invention, generally 400, is shown, where the system 400, is an energy conversion system, combining a solid oxide fuel cell subsystem 410, a thermophotovoltaic cell subsystem 450, and a gas turbine subsystem 480. The solid oxide fuel cell subsystem 410 includes at least one reformer 412 and at least one solid oxide fuel cell (SOFC) 414.

The reformer 412 includes a fuel source 416 for supplying a fuel stream 418 to the reformer 412 and a steam source 420 for supplying a steam stream 422 to the reformer 412 via appropriate conduits. The reformer 412 reforms the fuel and steam into hydrogen gas and carbon dioxide gas. The hydrogen gas is forwarded to the SOFC 414 as a hydrogen stream 424, while the carbon dioxide leaves the reformer 412 as a carbon dioxide gas stream 426.

The SOFC 414 includes a oxygen gas source 428 for supplying an oxygen gas stream 430 to the SOFC 414 via appropriate conduits. The gases may be compressed for above ambient pressure operation of the reformer 414 and the SOFC 414, and the gas may be compressed by the turbine subsystem 480 or via a separate gas compressors 432, 434 and 436 to form a compressed fuel stream 438, a compressed steam stream 440, and a compressed oxygen stream 442, respectively. The SOFC 414 produces an exhaust stream 444 of essentially water vapor is therefore near but less than the operating temperature of the SOFC, and the high temperature water vapor can be used to power a gas turbine either directly or through a heat exchanger to another operating gas. The DC electrical output of the SOFC 414 is conveyed to via a SOFC electric conduit 446 to a power conditioner 402. The power conditioner 402 conditions input electric power into an output regulated electric power 404 that may be utilized by a load (not shown), which may be either a local load or the electrical grid.

As a result of the high temperature operation of the SOFC 414, the SOFC 414 must be insulated from its room temperature surroundings to prevent radiative/conductive heat losses to the surroundings. The radiant energy produce by the SOFC 414 is principally in the infrared range of the electromagnetic spectrum, which is used by the thermophotovoltaic cell subsystem 450. The infrared radiation may be absorbed and converted into electrical energy in the thermphotovoltaic (TPV) subsystem 450 in one thermophotovoltaic (TPV) cell 452 or a plurality of TPV cells 452. Such cells 452 are essentially solar cells (p-n junctions) having a small band gap that operate in the infrared part of the electromagnetic spectrum. The TPV cells 452 line the SOFC cells 414 and absorb the radiated infrared radiation from the SOFC cells 414 and converting a portion of the infrared radiation into electric energy.

Efficiency of the TPV subsystem 450 may be further enhanced through the addition of a selective emitter 454, which absorbs the broad infrared radiation from a heat source (Plank distribution) and re-emits a major portion of that radiation in a more narrow wavelength band that better coincides with the bandgap of the TPV material, thus increasing the amount of radiation absorbed by the TPV cells 452, and hence increasing efficiency. Such selective emitters 454 typically comprise silicon carbide, tungsten, oxides such as ytterbium oxide, erbium oxide and complex ternary and quaternary rare earth oxides along with mixed oxides of aluminum, cobalt and other metals. The TPV configuration referred to in this embodiment of the subsystem 450 incorporates both the TPV cells 452 and the selective emitter 454. The TPV subsystem 450 produces a DC output, which is conducted via an electrical conduit 456 to the power conditioner 402.

As noted, the exhaust stream 430 from the SOFC 414 contains essentially water vapor at near the temperature of operation of the SOFC 414. Because a typical SOFC operates near 50% efficiency nearly ½ of the energy going into the SOFC 414 as chemical energy is lost in the exhaust stream 430 as heat. Much of this lost heat energy can be recouped by passing the exhaust stream 430 through a gas turbine subsystem 480. The subsystem 480 includes at least one gas turbine 482. The SOFC exhaust stream 430 is forwarded to the turbine 482, where the turbine 482 converts a portion of the heat in the stream 430 to form a spent exhaust stream 484 and to produce electrical energy. The turbine configuration referred to in this embodiment 480 incorporates both the turbine and an electrical generator. The electrical generator output (either AC or DC) is forwarded to the conditioner 402 via a turbine electrical conduit 486, which converts the power to a regulated power 404 that can be utilized by the load which could be either a local load or the electrical grid.

The turbine subsystem 480 also includes a Carnot heat engine 488. The Carnot engine 488 utilizes the spent exhaust stream 482 from the turbine 482 to produce additional work output 490, which will further increase the efficiency of the total system 400.

### Fifth Embodiment

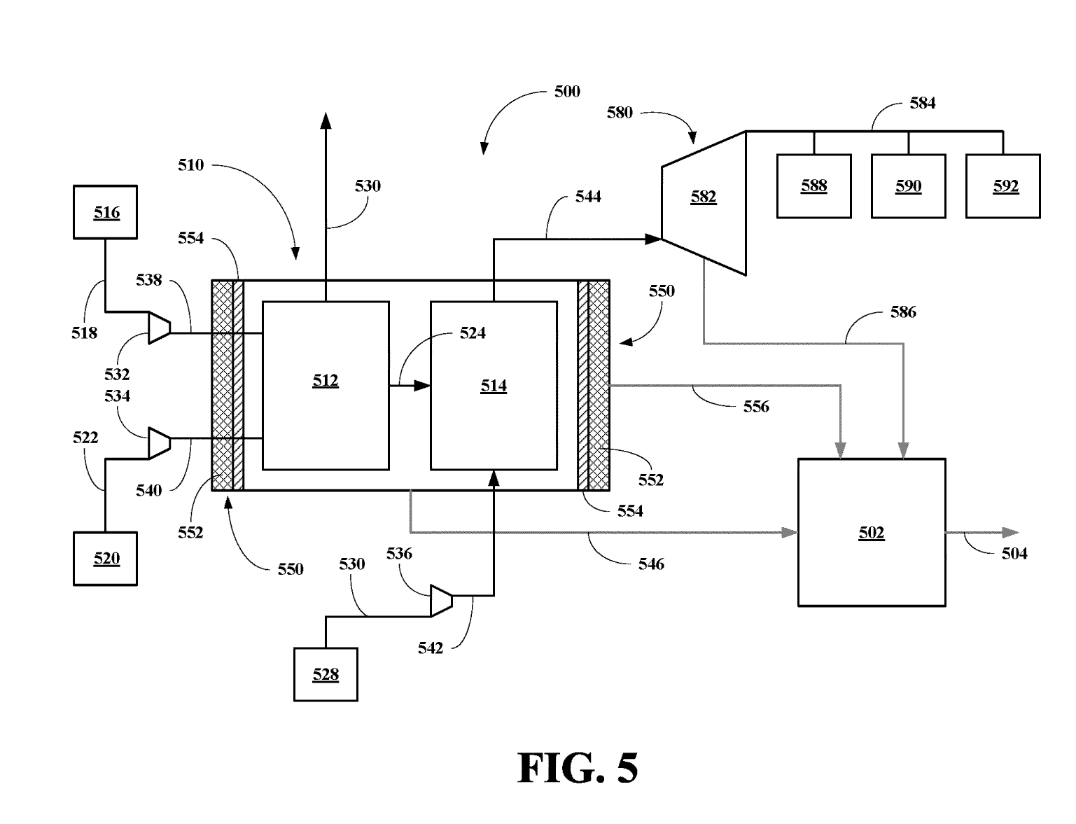

Referring now to FIG. 5, another embodiment of the system of this invention, generally 500, is shown, where the system 500, is an energy conversion system, combining a solid oxide fuel cell subsystem 510, a thermophotovoltaic cell subsystem 550, and a gas turbine subsystem 580. The solid oxide fuel cell subsystem 510 includes at least one reformer 512 and at least one solid oxide fuel cell (SOFC) 514.

The reformer 512 includes a fuel source 516 for supplying a fuel stream 518 to the reformer 512 and a steam source 520 for supplying a steam stream 522 to the reformer 512 via appropriate conduits. The reformer 512 reforms the fuel and steam into hydrogen gas and carbon dioxide gas. The hydrogen gas is forwarded to the SOFC 514 as a hydrogen stream 524, while the carbon dioxide leaves the reformer 512 as a carbon dioxide gas stream 526.

The SOFC 514 includes a oxygen gas source 528 for supplying an oxygen gas stream 530 to the SOFC 514 via appropriate conduits. The gases may be compressed for above ambient pressure operation of the reformer 514 and the SOFC 514, and the gas may be compressed by the turbine subsystem 580 or via a separate gas compressors 532, 534 and 536 to form a compressed fuel stream 538, a compressed steam stream 540, and a compressed oxygen stream 542, respectively. The SOFC 514 produces an exhaust stream 544 of essentially water vapor is therefore near but less than the operating temperature of the SOFC, and the high temperature water vapor can be used to power a gas turbine either directly or through a heat exchanger to another operating gas. The DC electrical output of the SOFC 514 is conveyed to via a SOFC electric conduit 546 to a power conditioner 502. The power conditioner 502 conditions input electric power into an output regulated electric power 504 that may be utilized by a load (not shown), which may be either a local load or the electrical grid.

As a result of the high temperature operation of the SOFC 514, the SOFC 514 must be insulated from its room temperature surroundings to prevent radiative/conductive heat losses to the surroundings. The radiant energy produce by the SOFC 514 is principally in the infrared range of the electromagnetic spectrum, which is used by the thermophotovoltaic cell subsystem 550. The infrared radiation may be absorbed and converted into electrical energy in the thermphotovoltaic (TPV) subsystem 550 in one thermophotovoltaic (TPV) cell 552 or a plurality of TPV cells 552. Such cells 552 are essentially solar cells (p-n junctions) having a small band gap that operate in the infrared part of the electromagnetic spectrum. The TPV cells 552 line the SOFC cells 514 and absorb the radiated infrared radiation from the SOFC cells 514 and converting a portion of the infrared radiation into electric energy.

Efficiency of the TPV subsystem 550 may be further enhanced through the addition of a selective emitter 554, which absorbs the broad infrared radiation from a heat source (Plank distribution) and re-emits a major portion of that radiation in a more narrow wavelength band that better coincides with the bandgap of the TPV material, thus increasing the amount of radiation absorbed by the TPV cells 552, and hence increasing efficiency. Such selective emitters 554 typically comprise silicon carbide, tungsten, oxides such as ytterbium oxide, erbium oxide and complex ternary and quaternary rare earth oxides along with mixed oxides of aluminum, cobalt and other metals. The TPV configuration referred to in this embodiment of the subsystem 550 incorporates both the TPV cells 552 and the selective emitter 554. The TPV subsystem 550 produces a DC output, which is conducted via an electrical conduit 556 to the power conditioner 502.

As noted, the exhaust stream 530 from the SOFC 514 contains essentially water vapor at near the temperature of operation of the SOFC 514. Because a typical SOFC operates near 50% efficiency nearly ½ of the energy going into the SOFC 514 as chemical energy is lost in the exhaust stream 530 as heat. Much of this lost heat energy can be recouped by passing the exhaust stream 530 through a gas turbine subsystem 580. The subsystem 580 includes at least one gas turbine 582. The SOFC exhaust stream 530 is forwarded to the turbine 582, where the turbine 582 converts a portion of the heat in the stream 530 to form a spent exhaust stream 584 and to produce electrical energy. The turbine configuration referred to in this embodiment 580 incorporates both the turbine and an electrical generator. The electrical generator output (either AC or DC) is forwarded to the conditioner 502 via a turbine electrical conduit 586, which converts the power to a regulated power 504 that can be utilized by the load which could be either a local load or the electrical grid.

The turbine subsystem 580 may also includes heat utilization units 588, 590, 592 and/or other units, which utilize residual heat in the spent turbine exhaust stream 584. The unit 588 may be a high temperature sea water desalination unit. The unit 590 may be a water heating unit. The unit 592 may be an air or gas heating unit. Other units may also utilize the in the spent turbine exhaust stream 584 such as drying units, thermal storage units, or other heat utilizing units. These units further increase the efficiency of the total system 500.

### Sixth Embodiment

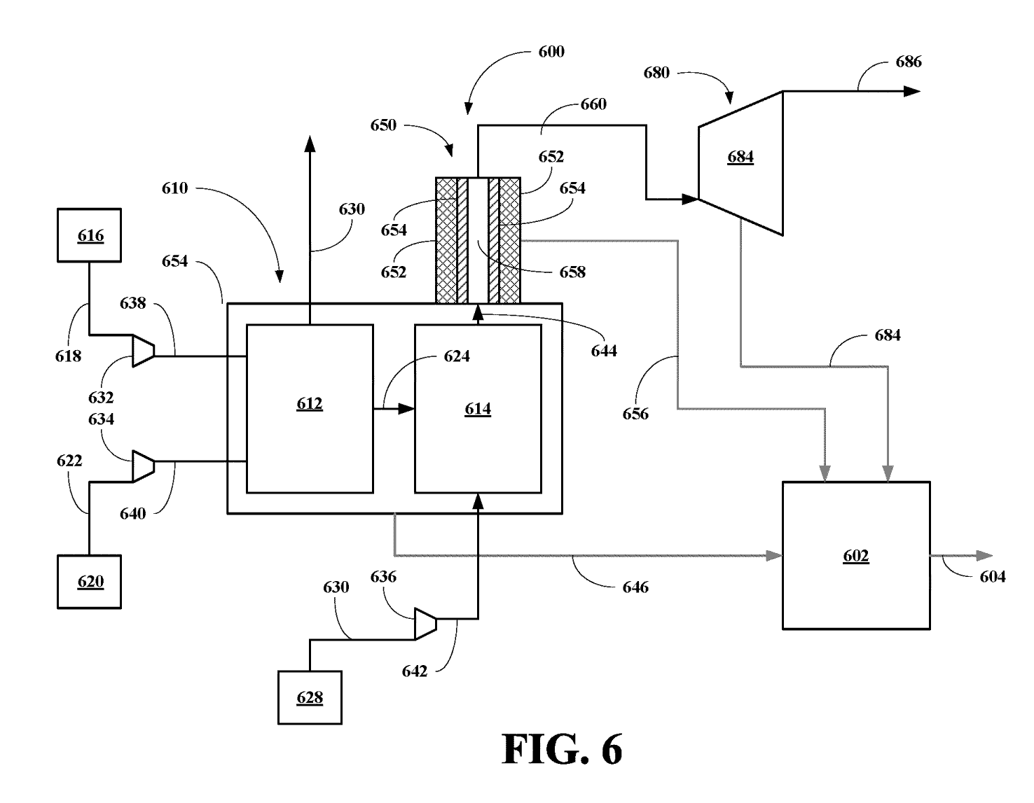

Referring now to FIG. 6, another embodiment of the system of this invention, generally 600, is shown, where the system 600, is an energy conversion system, combining a solid oxide fuel cell subsystem 610, a thermophotovoltaic cell subsystem 650, and a gas turbine subsystem 680. The solid oxide fuel cell subsystem 610 includes at least one reformer 612 and at least one solid oxide fuel cell (SOFC) 614.

The reformer 612 includes a fuel source 616 for supplying a fuel stream 618 to the reformer 612 and a steam source 620 for supplying a steam stream 622 to the reformer 612 via appropriate conduits. The reformer 612 reforms the fuel and steam into hydrogen gas and carbon dioxide gas. The hydrogen gas is forwarded to the SOFC 614 as a hydrogen stream 624, while the carbon dioxide leaves the reformer 612 as a carbon dioxide gas stream 626.

The SOFC 614 includes a oxygen gas source 628 for supplying an oxygen gas stream 630 to the SOFC 614 via appropriate conduits. The gases may be compressed for above ambient pressure operation of the reformer 614 and the SOFC 614, and the gas may be compressed by the turbine subsystem 680 or via a separate gas compressors 632, 634 and 636 to form a compressed fuel stream 638, a compressed steam stream 640, and a compressed oxygen stream 642, respectively.

The SOFC 614 produces an exhaust stream 644 of essentially water vapor is therefore near but less than the operating temperature of the SOFC, and the high temperature water vapor can be used to power a gas turbine either directly or through a heat exchanger to another operating gas. The DC electrical output of the SOFC 614 is conveyed to via a SOFC electric conduit 646 to a power conditioner 602. The power conditioner 602 conditions input electric power into an output regulated electric power 604 that may be utilized by a load (not shown), which may be either a local load or the electrical grid.

As a result of the high temperature operation of the SOFC 614, the SOFC 614 must be insulated from its room temperature surroundings to prevent radiative/conductive heat losses to the surroundings. The radiant energy produce by the SOFC 614 is principally in the infrared range of the electromagnetic spectrum, which is used by the thermophotovoltaic cell subsystem 650, where the infrared radiation is absorbed and converted into electrical energy. In this embodiment, the thermphotovoltaic (TPV) subsystem 650 is not directly associated with the SOFC 614, but instead the TPV subsystem 650 is brought in contact with the exhaust stream 644 in a heat transfer unit 658 surrounded by a thermophotovoltaic (TPV) cell 652. The cell 652 is essentially solar cells (p-n junctions) having a small band gap that operate in the infrared part of the electromagnetic spectrum. The TPV cell 652 absorb the radiated infrared radiation from the exhaust stream 644 passing through the unit 658 converting a portion of the infrared radiation into electric energy and producing a cooled exhaust stream 660. This embodiment 650 illustrates the possibility of locating the TPV cells 652 at the high temperature exhaust of the SOFC 614. The TPV cells 652 can operate at exhaust temperatures, or if needed, some additional fuel may be reacted in the SOFC exhaust to increase the temperature in the unit 658 resulting in increased power output of the TPV subsystem 650.

Efficiency of the TPV subsystem 650 may be further enhanced through the addition of a selective emitter 654, which absorbs the broad infrared radiation from a heat source (Plank distribution) and re-emits a major portion of that radiation in a more narrow wavelength band that better coincides with the bandgap of the TPV material, thus increasing the amount of radiation absorbed by the TPV cells 652, and hence increasing efficiency. Such selective emitters 662 typically comprise silicon carbide, tungsten, oxides such as ytterbium oxide, erbium oxide and complex ternary and quaternary rare earth oxides along with mixed oxides of aluminum, cobalt and other metals. The TPV configuration referred to in this embodiment of the subsystem 650 incorporates both the TPV cells 652 and the selective emitter 654. The TPV subsystem 650 produces a DC output, which is conducted via an electrical conduit 656 to the power conditioner 602.

As noted, the exhaust stream 630 from the SOFC 614 contains essentially water vapor at near the temperature of operation of the SOFC 614. Because a typical SOFC operates near 50% efficiency nearly ½ of the energy going into the SOFC 614 as chemical energy is lost in the exhaust stream 630 as heat. Much of this lost heat energy can be recouped by passing the exhaust stream 630 through a gas turbine subsystem 680. The subsystem 680 includes at least one gas turbine 682. The SOFC exhaust stream 630 is forwarded to the turbine 682, where the turbine 682 converts a portion of the heat in the stream 630 to form a spent exhaust stream 684 and to produce electrical energy. The turbine configuration referred to in this embodiment 680 incorporates both the turbine and an electrical generator. The electrical generator output (either AC or DC) is forwarded to the conditioner 602 via a turbine electrical conduit 686, which converts the power to a regulated power 604 that can be utilized by the load which could be either a local load or the electrical grid. The turbine exhaust stream 684 may be vented, or as described in another embodiment, may be channeled to a Carnot heat engine as described below or used as process heat. This process heat may also be used to pre-heat the hydrogen and/or the oxygen for the fuel cell 614.

While preferred embodiments have been shown and described, various modifications and substitutions may be made to the SOFC/Turbine/TPV system without departing from the spirit and scope of the invention. It is understood that the present invention has been described by way of illustration only, and that such illustrations disclosed here are not to be construed as limiting to the invention as the same can be varied in many ways. Such variations are not to be regarded as departure from the spirit and scope of the present invention, and all such modifications as would be obvious to one skilled in the art are intended to be included within the scope of this disclosure.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A system for generating electrical energy comprising:
a fuel cell subsystem including at least one solid oxide fuel cell, where the subsystem converts a portion of chemical energy released in the reaction of hydrogen with oxygen into a first amount of electrical energy and produces a hot exhaust gas comprising substantially water vapor, where each fuel cell includes a hydrogen gas input connected to a hydrogen gas source and an oxygen gas input connected to an oxygen source,
a turbine subsystem connected to a bottoming side of the fuel cells, where the turbine subsystem includes at least one gas turbine, which converts a portion of heat energy in the hot exhaust gas from the fuel cells into a second amount of electrical energy and forms a turbine exhaust gas, and
a thermophotovoltaic subsystem including at least one thermophotovoltaic cell in thermal contact with the fuel cells, where the thermophotovoltaic subsystem converts a portion of radiant energy produced by the fuel cells into a third portion of electrical energy.

2. The system of claim 1, wherein the radiant energy is infrared radiant energy.

3. The system of claim 1, wherein the thermophotovoltaic cells are in direct thermal contact with the fuel cells.

4. The system of claim 1, wherein the thermophotovoltaic cells are in indirect thermal contact with the fuel cell via a high temperature heat transfer fluid.

5. The system of claim 1, wherein the thermophotovoltaic cells are in direct thermal contact with the hot exhaust gas from the fuel cells.

6. The system of claim 1, wherein the thermophotovoltaic subsystem further includes an emitter coupled to each thermophotovoltaic cell, where the emitters are adapted to convert a portion of the radiant energy into a narrow range of infrared radiant energy to improve an efficiency of the thermophotovoltaic cells.

7. The system of claim 1, further comprising:
a power conditioner adapted to receive the three electrical energy amounts and produce a regulated electrical energy output, where the regulated electrical energy output is used by a load connected to the system or is fed into a power grid.

8. The system of claim 1, wherein the fuel cell subsystem further includes at least one reformer having a fuel input connected to a fuel source and a steam input connected to a steam source, where the reformer converts the fuel in the presence of steam into hydrogen gas and carbon dioxide gas, the hydrogen gas is forwarded to the hydrogen gas input of the fuel cells and the carbon dioxide gas is vented or sequestered.

9. The system of claim 1, further comprising:
a Carnot heat engine connected to the turbine, where the Carnot heat engine converts a portion of residual heat in the turbine exhaust gas to usable form of energy.

10. The system of claim 1, further comprising:
a heat utilization unit or a plurality of heat utilization units, where the units utilize a portion of residual heat in the turbine exhaust gas and where the units comprise a water heating unit, an air or gas heating unit, a drying unit, a desalination unit and/or other units that utilized waste heat.

11. A system for generating electrical energy comprising:
a fuel cell subsystem including at least one solid oxide fuel cell and at least one reformer, where the subsystem converts a portion of chemical energy released in the reaction of hydrogen with oxygen into a first amount of electrical energy and produces a hot exhaust gas comprising substantially water vapor, where each fuel cell includes a hydrogen gas input and an oxygen gas input connected to an oxygen source, and where each reformer includes a fuel input connected to a fuel source and a steam input connected to a steam source, where the reformer converts the fuel in the presence of steam into hydrogen gas and carbon dioxide gas, the hydrogen gas is forwarded to the hydrogen gas input of the fuel cells and the carbon dioxide gas is vented or sequestered;
a turbine subsystem connected to a bottoming side of the fuel cells, where the turbine subsystem includes at least one gas turbine, which converts a portion of heat energy in the hot exhaust gas from the fuel cells into a second amount of electrical energy and forms a turbine exhaust gas; and
a thermophotovoltaic subsystem including at least one thermophotovoltaic cell in thermal contact with the fuel cells, where the thermophotovoltaic subsystem converts a portion of radiant energy produced by the fuel cells into a third portion of electrical energy.

12. The system of claim 11, wherein the radiant energy is infrared radiant energy.

13. The system of claim 11, wherein the thermophotovoltaic cells are in direct thermal contact with the fuel cells.

14. The system of claim 11, wherein the thermophotovoltaic cells are in indirect thermal contact with the fuel cell via a high temperature heat transfer fluid.

15. The system of claim 11, wherein the thermophotovoltaic cells are in direct thermal contact with the hot exhaust gas from the fuel cells.

16. The system of claim 11, wherein the thermophotovoltaic subsystem further includes an emitter coupled to each thermophotovoltaic cell, where the emitters are adapted to convert a portion of the radiant energy into a narrow range of infrared radiant energy to improve an efficiency of the thermophotovoltaic cells.

17. The system of claim 11, further comprising:
a power conditioner adapted to receive the three electrical energy amounts and produce a regulated electrical energy output, where the regulated electrical energy output is used by a load connected to the system or is fed into a power grid.

18. The system of claim 11, further comprising:
a Carnot heat engine connected to the turbine, where the Carnot heat engine converts a portion of residual heat in the turbine exhaust gas to usable form of energy.

19. The system of claim 11, further comprising:
a heat utilization unit or a plurality of heat utilization units, where the units utilize a portion of residual heat in the turbine exhaust gas and where units comprise a water heating unit, an air or gas heating unit, a drying unit, a desalination unit and/or other units that utilized waste heat.

20. A method for generating electrical energy comprising:
generating a first amount of electrical energy in a fuel cell subsystem including at least one solid oxide fuel cell, where the subsystem converts a portion of chemical energy released in the reaction of hydrogen with oxygen into the first amount of electrical energy and produces a hot exhaust gas comprising substantially water vapor, where each fuel cell includes a hydrogen gas input connected to a hydrogen gas source and an oxygen gas input connected to an oxygen source,
generating a second amount of electrical energy in a turbine subsystem connected to a bottoming side of the fuel cells, where the turbine subsystem includes at least one gas turbine, which converts a portion of heat energy in the hot exhaust gas from the fuel cells into the second amount of electrical energy, and
generating a third amount of electrical energy in a thermophotovoltaic subsystem including at least one thermophotovoltaic cell in thermal contact with the fuel cells, where the thermophotovoltaic subsystem converts a portion of radiant energy produced by the fuel cells into the third portion of electrical energy.

21. The method of claim 19, further comprising:
conditioning the three amounts of electrical energy in a conditioning unit to form a regulated electrical energy output, where the regulated electrical energy output drives a load and/or is fed into an electrical power grid.
